(19) United States
(12) Patent Application Publication
(10) Pub. No.: US 2008/0081777 A1
(43) Pub. Date: Apr. 3, 2008

(54) Cleaning agent composition

(75) Inventors: Satoshi Bunne, Anjo-city (JP); Shouzou Ikejima, Okazaki-city (JP); Kouichi Nagaya, Nagoya-city (JP); Shinji Abo, Anjo-city (JP); Masakazu Iori, Takahama-city (JP); Takayuki Takai, Chiryu-city (JP); Noriyuki Suzuki, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/904,292

(22) Filed: Sep. 26, 2007

(30) Foreign Application Priority Data
Sep. 28, 2006 (JP) 2006-264135

(51) Int. Cl. C11D 3/18; C11D 3/20

(52) U.S. Cl. 510/185

(57) ABSTRACT

Disclosed is a cleaning agent composition which is used for cleaning and removing deposits adhered to an object to be cleaned. The cleaning agent composition comprises a hydrocarbon-based base material, a surfactant and water. The content of the surfactant is from 0.1 to 50% by weight, the content of water is from 0.01 to 5% by weight based on the entire cleaning agent composition, and the balance is the base material, based on the entire cleaning agent composition. The base material is preferably light oil or gasoline, and the base material may be an organic solvent. The base material preferably has a dynamic viscosity at 30° C. in a range from 0.5 to 20 mm²/s.

### TECHNICAL FIELD

The present invention relates to a cleaning agent composition.

### BACKGROUND ART

It has been known that deposits adhere to components and the like, which are in direct contact with fuel of an internal combustion engine, such as an engine interior and injection nozzle of a fuel injection apparatus, due to an extended period of use. These components have to be cleaned of deposits, in order to operate efficiently. Conventionally, cleaning agents which contain a polybutene amine or a polyether amine as a main component have been used for removing deposits (Japanese Unexamined Patent Publication No. 57-101676, Japanese Examined Patent Publication No. 02-42878).

Although these cleaning agents can be used for removing carbon-based deposits, they generally have little effect on cleaning and removing mixed deposits containing water-soluble deposits composed of sodium or potassium compounds which adhere to an inside of a fuel injection apparatus, and water-insoluble deposits composed of degraded fuels, additives and the like.

Therefore, it has been desired to develop a cleaning agent which is very effective at cleaning such mixed deposits.

### SUMMARY OF INVENTION

The present invention has been made to solve the above problem of the prior art, and an object of the present invention is to provide a cleaning agent capable of cleaning and removing mixed deposits containing both water-soluble and water-insoluble deposits.

The present invention provides, as a first aspect, a cleaning agent composition used for cleaning and removing deposits adhered to an object to be cleaned, comprising a hydrocarbon-based base material, a surfactant and water, wherein

the content of the surfactant is from 0.1 to 50% by weight based on the entire cleaning agent composition,

the content of water is from 0.01 to 5% by weight based on the entire cleaning agent composition, and

the balance is the hydrocarbon-based base material.

The cleaning agent composition allows simultaneous cleaning and removal of both the water-soluble and water-insoluble deposits, by adjusting the contents of the surfactant and water in the hydrocarbon-based base material, as described above.

The content of the surfactant in a range from 0.1 to 50% by weight based on the entire cleaning agent composition provides the cleaning effect on the water-insoluble deposits and stable dispersion of water.

The content of the surfactant in a range from 0.1 to 50% by weight based on the entire cleaning agent composition provides the advantageous cleaning effect on the water-insoluble deposits and stable dispersion of water.

The content of water in a range from 0.01 to 5% by weight provides the advantageous effect of cleaning and removing of the water-soluble deposits.

The cleaning agent composition, with stable dispersion of a surfactant and water in the hydrocarbon-based base material having low affinity for water, allows the cleaning and removing of the water-insoluble deposits by the surfactant, and at the same time, the cleaning and removing of the water-soluble deposits by water, and thus allows the cleaning and removing of the mixed deposits.

In addition, even if an object to be cleaned can be corroded by water, the component can be protected from corrosion by limiting the content of water within the aforementioned range and stably dispersing it.

Thus, the present invention provides a cleaning agent composition capable of cleaning and removing mixed deposits containing both water-soluble and water-insoluble deposits.

The present invention also provides, as a second aspect, a method of cleaning and removing deposits adhered to an object to be cleaned in contact with the fuel of an internal combustion engine, comprising a step of using a cleaning agent composition comprising a hydrocarbon-based base material, a surfactant and water, wherein

the content of the surfactant is from 0.1 to 50% by weight based on the entire cleaning agent composition,

the content of water is from 0.01 to 5% by weight based on the entire cleaning agent composition, and

the balance is the hydrocarbon-based base material.

It must be understood that the same cleaning agent composition as the one described for the first aspect of the present invention can also be used in the method of cleaning and removing deposits adhered to an object to be cleaned in contact with the fuel of an internal combustion engine, described as the second aspect of the present invention.

It must also be understood that the method of the present invention can provide similar advantageous effects to ones provided by the cleaning agent composition of the first aspect of the present invention, since the same cleaning agent composition is used.

### DETAILED DESCRIPTION

The cleaning agent composition of the present invention comprises a hydrocarbon-based base material, a surfactant and water.

Examples of the hydrocarbon-based base material include, but are not limited to, light oil, gasoline, an organic solvent and the like, as described in more detail later.

Examples of the surfactant include, but are not limited to, an anionic surfactant, a cationic surfactant, a nonionic surfactant, an amphoteric ionic surfactant, a polymeric surfactant, a fluoric surfactant, a reactive surfactant and the like.

The anionic surfactants include, for example a fatty acid salt, an alkylbenzene sulfonate, an alkylsulphate, an alpha-olefin sulfonate and an alkyl ether sulfate salt.

The cationic surfactants include, for example an alkyl trimethyl ammonium salt, a dialkyl dimethyl ammonium chloride and an alkyl pyridinium chloride.

The nonionic surfactants include, for example a fatty acid diethanolamide, a polyoxyethylene alkylether and a polyoxyethylene alkylphenylether.

The amphoteric surfactants include, for example an alkylamine oxide, an alkylamino fatty acid salt and an alkylcarboxy betaine.

The polymeric surfactants include, for example a cationic cellulose derivative, a polycarboxylic acid and a polystyrene sulfonic acid.

The fluoric surfactants include, for example an anionic fluoric surfactant, a cationic fluoric surfactant, a nonionic fluoric surfactant and an amphoteric fluoric surfactant.

The reactive surfactants include, for example an allyl base reactive surfactant.

The content of the surfactant is in a range of 0.1 to 50% by weight based on the entire cleaning agent composition.

When the content of the surfactant is less than 0.1% by weight, there arises a problem that removing water-insoluble deposits is insufficient. On the other hand, when the content of the surfactant exceeds 50% by weight, there arises a problem that the handling thereof is difficult due to increasing the viscosity of the cleaning agent composition.

The content of water is in a range of 0.01 to 5% by weight.

When the content of water is lower than 0.01% by weight, there arises a problem that an effect of removing water-soluble deposits becomes insufficient. On the other hand, when the content of water exceeds 5% by weight, there arises a problem that the cleaning agent composition may cause an adverse effect to a system including the object to be cleaned, such as corrosion.

The ratio of the water content to the surfactant content is preferably 0.1 or less. When the ratio is 0.1 or less, water can be dispersed more stably in the cleaning agent composition. When the ratio exceeds 0.1, water may not be dispersed stably and may have an adverse effect on the system processing the object to be cleaned.

In a preferable embodiment of the present invention, the hydrocarbon-based base material of the cleaning agent composition is preferably light oil or gasoline.

Light oil or gasoline has relatively high volatility, and when it is used as the base material, the cleaning agent composition can be easily removed from the cleaning system after completing cleaning the deposits. Especially, as described later, when the object to be cleaned is a component in contact with the fuel of an internal-combustion engine, the fuel in most cases, is either light oil or gasoline. Therefore, using light oil or gasoline as the base material is highly effective for cleaning such an object to be cleaned.

The aforementioned light oil is specified in JIS K 2204, and the aforementioned gasoline is specified in JIS K 2202.

In another preferable embodiment of the present invention, an organic solvent may also be used as the base material.

The advantageous effect of using the organic solvent is basically the same as that of using light oil or gasoline.

In another preferable embodiment of the present invention, the base material has a preferable dynamic viscosity at 30° C. in a range from 0.5 to 20 mm²/s. In this case, excellent fluidity can be obtained.

When the dynamic viscosity is less than 0.5 mm²/s, there is possibility of increasing wear on sliding portions in contact with the fuel of an internal-combustion engine. When the dynamic viscosity exceeds 20 mm²/s, there is possibility of difficulty of handling due to the high viscosity.

In another preferable embodiment of the present invention, the surfactant is preferably polyethylene glycol laurylamine.

In this case, the surfactant has a cleaning agent composition which provides excellent cleaning and removing properties for the water-soluble and water-insoluble deposits.

In another embodiment of the present invention, it is also preferable to add alcohol to the cleaning agent composition.

In this case, as the addition of alcohol can lower the freezing point of the cleaning agent composition, the fluidity required for the cleaning operation can be maintained, even in cold environments.

In another embodiment of the present invention, the content of the alcohol in the cleaning agent composition is preferably 0.2 times or more the content of the surfactant. In this case, excellent fluidity can also be obtained.

In another embodiment of the present invention, the alcohol is preferably a compound which has one or more hydroxyl groups, and contains 2 to 6 carbon atoms. In this case, excellent fluidity can also be obtained.

When the alcohol has one carbon atom, the alcohol may exert an adverse influence on a component made of rubber or a resin in a system including the object to be cleaned. When the alcohol has 7 or more carbon atoms, the fluidity of the cleaning agent composition may not be ensured at low temperatures.

Examples of the alcohol include, but are not limited to, isopropyl alcohol, isobutyl alcohol, diethylene glycol monoethyl ether and the like.

Furthermore, in another embodiment of the present invention, the cleaning agent composition is preferably used for cleaning and removing deposits adhered to components, which is the object to be cleaned and is in contact with the fuel of an internal combustion engine.

As described above, in many cases of cleaning and removing deposits adhered to the components in contact with the fuel of an internal combustion engine, the deposits contain both the water-soluble and water-insoluble deposits, which are difficult to be simultaneously removed by conventional cleaning agents. The cleaning agent composition of the present invention is especially effective at cleaning such deposits, since both the surfactant which is effective at removing the water-insoluble deposits, and water which is effective at removing the water-soluble deposits can be stably dispersed in the base material. In addition, the cleaning agent composition of the present invention is applicable to other various purposes, without specifying the object to be cleaned.

The cleaning agent composition of the present invention basically comprises a hydrocarbon-based base material, surfactant and water, and further comprises optionally alcohol. However, it should be noted that other various additives may be added to the cleaning agent composition of the present invention for various purposes, as long as the action and effect of the present invention are not adversely affected.

### EXAMPLES

### Example 1

Examples of the cleaning agent composition of the present invention will be described by this example.

The cleaning agent composition of the present invention comprises a hydrocarbon-based base material, a surfactant and water.

As the Examples of the present invention and the Comparative examples, the cleaning agent compositions (Samples E1 to E10, and Samples C1 to C3) with the compositions shown in Table 1 and Table 2 were prepared.

TABLE 1

| | Base | | | | | | | | | | | | |
|---|---|---|---|---|---|---|---|---|---|---|---|---|---|
| | material | | | | | | | | | | | | |
| | (% by | | | | | | | | | | | | |
| | weight) | Surfactants | | | | | | | Water | Cleaning | | | |
| | Light | (% by | | | | | | | content | properties | | Evaluation | |
| | oil (JIS | weight) | | | | | | | (% by | Cleaning | | of anti- | Total |
| Samples | No. 2) | A | B | C | D | E | F | G | weight) | rate (%) | Evaluation | corrosiveness | evaluation |
| E1 | 96.9 | 3 | | | | | | | 0.1 | 100 | E¹⁾ | G | E |
| E2 | 96.9 | | 3 | | | | | | 0.1 | 35 | G²⁾ | G | G |
| E3 | 96.9 | | | 3 | | | | | 0.1 | 40 | G | G | G |
| E4 | 96.9 | | | | 3 | | | | 0.1 | 35 | G | G | G |
| E5 | 96.9 | | | | | 3 | | | 0.1 | 50 | G | G | G |
| E6 | 96.9 | | | | 3 | | | | 0.1 | 35 | G | G | G |
| E7 | 96.9 | | | 3 | | | | | 0.1 | 40 | G | G | G |
| E8 | 96.9 | | | | | | 3 | | 0.1 | 4 | G | G | G |
| E9 | 96.9 | | | | | | | 3 | 0.1 | 35 | G | G | G |
| E10 | 45 | 50 | | | | | | | 5 | 100 | E | G | E |

¹⁾Excellent,
²⁾Good

As shown in Table 1, in each of Samples E1 to E10 as Examples of the present invention, the content of the surfactant is 0.01 to 20% by weight, the content of the water is 0.01 to 5% by weight, and the content of a hydrocarbon-based base material is the balance, based on the entire cleaning agent composition.

TABLE 2

| | Base | | | | | | | | | | | | |
|---|---|---|---|---|---|---|---|---|---|---|---|---|---|
| | material | | | | | | | | | | | | |
| | (% by | | | | | | | | | | | | |
| | weight) | Surfactants | | | | | | | Water | Cleaning | | | |
| | Light | (% by | | | | | | | content | properties | | Evaluation | |
| Sam- | oil (JIS | weight) | | | | | | | (% by | Cleaning | | of anti- | Total |
| ples | No. 2) | A | B | C | D | E | F | G | weight) | rate (%) | Evaluation | corrosiveness | evaluation |
| C1 | 23 | 70 | — | — | — | — | — | — | 7 | 100 | E¹⁾ | P | P |
| C2 | 99.945 | 0.05 | — | — | — | — | — | — | 0.005 | 15 | P³⁾ | G²⁾ | P |
| C3 | 80 | 10 | — | — | — | — | — | — | 10 | 100 | E | P | P |

¹⁾Excellent,
²⁾Good,
³⁾Poor

Symbols in Tables 1 and 2 are as follows:
A: Polyethylene glycol laurylamine
B: Polyethylene glycol oleylether
C: Polyethylene glycol monooleate
D: Polyethylene glycol monolaurate
E: Sorbitan monooleate
F: Polyoxyethylene octylphenol ether
G: Polyoxyethylene nonylphenol ether

Next, a test for evaluation of cleaning properties was carried out using each of the Samples E1-E10 and C1-C3, and then the cleaning properties were evaluated to obtain the total evaluation. The results are shown in Table 1 and Table 2.

Test for Evaluation of Cleaning Properties

In the test for evaluation of cleaning properties, test pieces were prepared by adhering the water-soluble deposits and water-insoluble deposits on metallic test pieces (SKH2). More specifically, an aqueous solution containing 15% of reagents of representative substances contained in the water-soluble deposits was prepared, and the substances contained in the water-soluble deposits were adhered on the metallic test pieces, by dipping the metallic test pieces in the aqueous solution, pulling them out from the solution, and then drying them. Next, a base-material solution containing 15% of reagents of representative substances contained in the water-insoluble deposits was prepared, and the substances contained in the water-insoluble deposits were adhered to the metallic test pieces, by dipping the metallic test pieces in the base-material solution, pulling them out from the solution, and then drying them.

After that, each of the pieces was subjected to a treatment of stirring for one hour in each sample of the cleaning agent composition to clean and remove the deposits. Subsequently, the amount of decrease in deposits was measured as well as weight loss of the test piece by using an electronic balance, and the cleaning properties of each sample were evaluated. The results were evaluated using three levels of “Excellent (E)”, “Good (G)” and “Poor (P)”, in which “E” or “G” is acceptable, while “P” is not acceptable.

Evaluation criteria:

E; the amount of decrease in deposits is 81 to 100%,

G; the amount of decrease in deposits is 31 to 80%,

P; the amount of decrease in deposits is 0 to 30%.

Evaluation of Anti-Corrosiveness

After the above test for evaluation of cleaning properties, the surface of each metallic test piece was visually inspected for corrosion. The observation results were evaluated using two levels of “Good (G)” or “Poor (P)”, in which “G” is acceptable, while “P” is not acceptable.

Evaluation Criteria:

G; corrosion is not observed,

P; corrosion is observed.

Total Evaluation

From the evaluation results of cleaning properties and anti-corrosiveness, the total evaluation was carried out. The result evaluated as “E” (Excellent) or “G” (Good) is acceptable, while “P” (Poor) is not acceptable.

Evaluation criteria:

E; cleaning properties are “E”, and anti-corrosiveness is “G”,

G; both the cleaning properties and anti-corrosiveness are “G”,

P; at least one of the cleaning properties and anti-corrosiveness is “P”.

As shown in Table 1, Samples E1-E10 as the Example of the present invention exhibited good or excellent cleaning properties of the deposits.

On the other hand, as shown in Table 2, Sample C1 as the Comparative example of the present invention was difficult to be handled due to the increased viscosity by the higher contents of the surfactant and water than the upper limits thereof respectively specified by the present invention.

In addition, Sample C2 as the Comparative example of the present invention exhibited poor cleaning properties due to the lower contents of the surfactant and water than the lower limits thereof respectively specified in the present invention, and was not acceptable.

Sample C3 as the Comparative example of the present invention exhibited a symptom of corrosion on the surface of the metallic test piece due to the higher content of water than the upper limit thereof specified in the present invention, and thus failed the total evaluation.

### Example 2

In this example, a low temperature fluidity limit test was performed for each cleaning agent composition of the present invention to evaluate the low temperature fluidity limit.

Samples E1-E10 of the cleaning agent compositions containing the water, surfactant and alcohol at each ratio shown in Table 3 were prepared.

It was determined whether or not each sample flows at a temperature of −5° C. to evaluate the low temperature fluidity limit. The results were evaluated using two levels of “Good” (G) representing that the Sample flows at −5° C., and “Poor (P)” representing that the Sample does not flow at −5° C.

TABLE 3

| | | Polyethylene | | Fluidity at |
|---|---|---|---|---|
| | | glycol | Isopropyl | low |
| Sample | Water | laurylamine | alcohol | temperature |
| E11 | 1 | 30 | 1 | P |
| E12 | 1 | 30 | 3 | P |
| E13 | 1 | 30 | 6 | G |
| E14 | 1 | 30 | 12 | G |

As shown in Table 3, Samples E11 and E12 did not flow at −5° C., due to the alcohol content lower than the lower limit of the preferable range specified in the present invention.

On the other hand, Samples E13 and E14, which contain an alcohol within a preferable range of the present invention, exhibited “Good” fluidity.

In view of workability, the content (% by weight) of the alcohol is preferably 0.2 times or more of the content of the surfactant in the cleaning agent composition of the present invention.

While the invention has been described in detail, it is to be clearly understood that this is intended by way of example only and is not to be taken by way of limitation, the spirit and scope of this invention being limited only by the terms of the following claims.

We claim:

1. A cleaning agent composition used for cleaning and removing deposits adhered to an object to be cleaned, comprising a hydrocarbon-based base material, a surfactant and water, wherein
the content of the surfactant is from 0.1 to 50% by weight based on the entire cleaning agent composition,
the content of water is from 0.01 to 5% by weight based on the entire cleaning agent composition, and
the balance is the hydrocarbon-based base material.

2. The cleaning agent composition according to claim 1, wherein the hydrocarbon-based base material is light oil or gasoline.

3. The cleaning agent composition according to claim 1, wherein the hydrocarbon-based base material is an organic solvent.

4. The cleaning agent composition according to claim 1, wherein the hydrocarbon-based base material has a dynamic viscosity at 30° C. in a range from 0.5 to 20 mm²/s.

5. The cleaning agent composition according to claim 1, wherein the surfactant is polyethylene glycol laurylamine.

6. The cleaning agent composition according to claim 1, wherein an alcohol is further added.

7. The cleaning agent composition according to claim 6, wherein, by representing with wt %, the content of the alcohol is 0.2 times of more of the content of the surfactant.

8. The cleaning agent composition according to claim 6, wherein the alcohol is a substance having 2 to 6 carbon atoms, and having one or more hydroxyl group.

9. The cleaning agent composition according to claim 1, which is used for cleaning and removing deposits adhered on a component, which is the object to be cleaned, in contact with a fuel of an internal combustion engine.

10. A method of cleaning and removing deposits adhered to an object to be cleaned in contact with a fuel of an internal combustion engine, comprising a step of using a cleaning agent composition comprising a hydrocarbon-based base material, a surfactant and water, wherein
the content of the surfactant is from 0.1 to 50% by weight based on the entire cleaning agent composition,
the content of water is from 0.01 to 5% by weight based on the entire cleaning agent composition, and
the balance is the hydrocarbon-based base material.
